(19) United States
(12) Patent Application Publication
(10) Pub. No.: US 2009/0061243 A1
(43) Pub. Date: Mar. 5, 2009

(54) Metal clad laminate and the manufacturing method thereof

(75) Inventors: Der-Jen Sun, Pingjhen City (TW); Yen-Huey Hsu, Pingjhen City (TW)

Correspondence Address: Joe McKinney Muncy, PO Box 1364, Fairfax, VA, 22038-1364, US

(73) Assignee: MORTECH CORPORATION

(21) Appl. No.: 12/007,360

(22) Filed: Jan. 9, 2008

(30) Foreign Application Priority Data
Aug. 31, 2007 (TW) 96132606

(51) Int. Cl. B32B 15/08; B05D 5/12

(52) U.S. Cl. 428/458; 427/99.4

(57) ABSTRACT

A method for manufacturing a metal clad laminate is provided. A poly(amic acid) solution is first formed. The poly(amic acid) solution includes a heat-conductive filler, a poly(amic acid) and a solvent. The thermal conductivity of the heat-conductive filler is higher than 10 W/m-° C. The content of the heat-conductive filler is about 10˜90 wt % of the solid content of the poly(amic acid) solution. Then, the poly(amic acid) solution is coated on a metal foil. Finally, the poly(amic acid) solution on the metal foil is heated to form a polyimide layer on the metal foil.

### RELATED APPLICATIONS

This application claims priority to Taiwan Application Serial Number 96132606, filed Aug. 31, 2007, which is herein incorporated by reference.

### BACKGROUND

1. Field of Invention

The present invention relates to a circuit board and the manufacturing method thereof. More particularly, the present invention relates to a metal clad laminate and the manufacturing method thereof.

2. Description of Related Art

Flexible printed circuit board (FPCB) is widely applied as a connector or a circuit board in various electronic products due to its flexible property. Among FPCB products available in the market, copper clad laminate is the most popular one.

The copper clad laminate includes a plastic substrate and a copper foil. The copper foil is located on the plastic substrate. Various electrical circuits are etched on the copper foil to connect various electronic devices bonded on the copper clad laminate. A large amount of heat could be generated from the electrical circuit when an electric current travels through the electrical circuit. The temperature of the copper clad laminate is rapidly increased if the heat mentioned above is not effectively transferred to a heat-dissipation device. Abnormal operation of the electronic device bonded on the copper clad laminate may occur due to rapid temperature increase of the copper clad laminate. Therefore, it is necessary to develop provide a copper clad laminate with improved thermal conductivity to avoid the problem mentioned above.

### SUMMARY

A method for manufacturing a metal clad laminate is provided. A poly(amic acid) solution is first formed. The poly(amic acid) solution includes a heat-conductive filler, poly(amic acid) and a solvent. The thermal conductivity of the heat-conductive filler is higher than 10 W/m-° C. The content of the heat-conductive filler is about 10˜90 wt % of the solid content of the poly(amic acid) solution. Then, the poly(amic acid) solution is coated on a metal foil. Finally, the poly(amic acid) solution on the metal foil is heated to form a polyimide layer on the metal foil.

A metal clad laminate is provided. The metal clad laminate includes a metal foil and a polyimide layer. The polyimide layer is located on a surface of the metal foil without any adhesive layer between the polyimide layer and the metal foil. The polyimide layer includes a heat-conductive filler. The thermal conductivity of the heat-conductive filler is higher than 10 W/m-° C. The content of the heat-conductive filler is about 10˜90 wt %.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 shows a flow chart of a copper clad laminate manufacturing process according to one embodiment of this invention; and

FIG. 2 is a sketch diagram of a manufacturing system applied in the manufacturing process shown in FIG. 1.

### DETAILED DESCRIPTION

A method for manufacturing a copper clad laminate according to one embodiment of present invention is provided. The copper clad laminate manufactured by the method given above possesses improved thermal conductivity property. By improving the thermal conductivity property of the copper clad laminate, the heat generated by electrical circuit located on the copper clad laminate can be effectively transferred to a heat-dissipation apparatus. The temperature of the copper clad laminate can be further reduced due to its improved thermal conductivity property. Besides, the copper mentioned above can be replaced with any appropriate metal foil, such as aluminum foil, iron foil or other alloy foils, to manufacture other metal clad laminates.

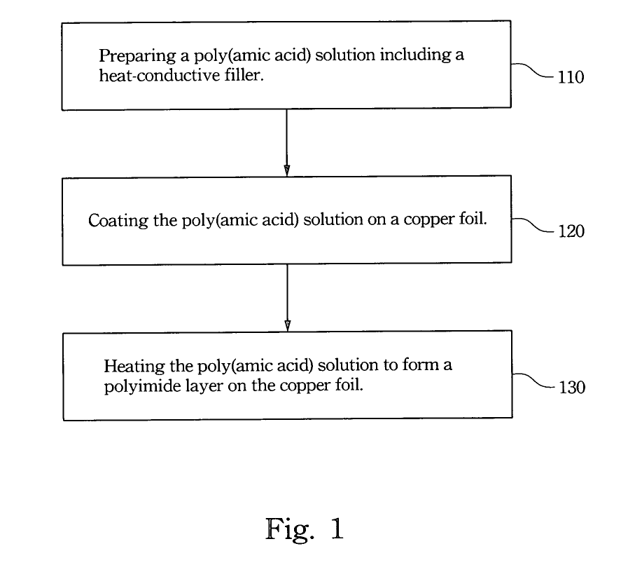

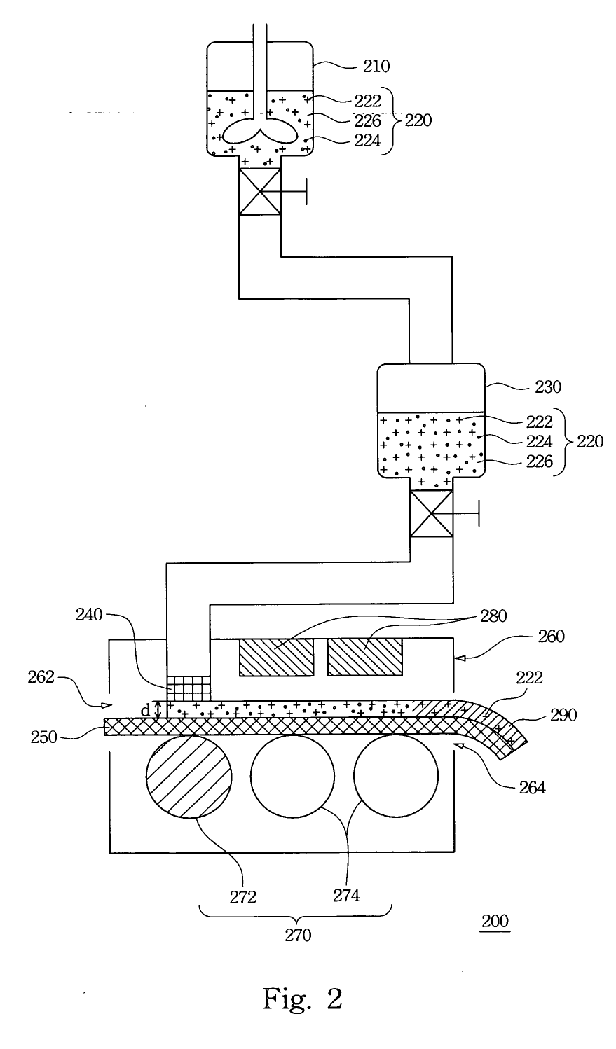

FIG. 1 shows a flow chart of a copper clad laminate manufacturing process according to one embodiment of this invention. FIG. 2 is a sketch diagram of a manufacturing system applied in the manufacturing process shown in FIG. 1. Referring to FIG. 1˜2, step 110 is carried out first. A poly(amic acid) solution 220 is prepared in a reactor 210 of a manufacturing system 200. The poly(amic acid) includes a heat-conductive filler 222, poly(amic acid) 224 and a solvent 226.

The preparation of the poly(amic acid) solution 220 can be carried out by any practicable method such as adding the heat-conductive filler 222 and at least one dianhydride monomer into the solvent 226 containing at least one diamine monomer dissolved therein. The poly(amic acid) 224 is formed in the solvent 226 by reacting the diamine monomer with the dianhydride monomer. The heat-conductive filler 222 is distributed in the poly(amic acid) 224 and the solvent 226.

The diamine monomer mentioned above can be aromatic diamine monomer selected from a group consisting of 1,4-diamino benzene, 1,3-diamino benzene, 4,4′-oxydianiline, 3,4′-oxydianiline, 4,4′-methylene dianiline, N,N′-di phenylethylenediamine, diaminobenzophenone, diamino diphenyl sulfone, 1,5-naphenylene diamine, 4,4′-diaminodiphenyl sulfide, 1,3-bis(3-aminophenoxy)benzene, 1,4-bis(4-aminophenoxy)benzene, 1,3-bis(4-aminophenoxy)benzene, 2,2-bis[4-(4-aminophenoxy)phenoxy]propane, 4,4′-bis-(4-aminophenoxy)biphenyl, 4,4′-bis-(3-aminophenoxy)biphenyl, 1,3-bis(3-aminopropyl)-1,1,3,3-tetramethyldisiloxane, 1,3-bis(3-aminopropyl)-1,1,3,3-tetraphenyldisiloxane, 1,3-bis(aminopropyl)dimethyldiphenyldisiloxane and a combination thereof.

The dianhydride monomer mentioned above can be aromatic dianhydride selected from a group consisting of 1,2,4,5-benzenetetracarboxylic dianhydride, 3,3′4,4′-biphenyltetracarboxylic-dianhydride, 4,4′-oxydiphthalic anhydride, benzo phenonetetracarboxylic dianhydride, 3,3′,4,4′-diphenylsulfonetetracarboxylic dianhydride, 1,2,5,6-naphthalenetetracarboxylicdianhydride, naphthalenetetra carboxylic dianhydride, bis(3,4-dicarboxyphenyl)dimethylsilane dianhydride, 1,3-bis(4′-phthalic anhydride)tetramethyldisiloxane and a combination thereof.

The solvent 226 mentioned above can be N,N-dimethylformamide, dimethylacetamide, dimethylsulfoxide, N-methyl-2-pyrrolidone, gamma butyrolatone or a combination thereof.

The heat-conductive filler 222 can be an inorganic filler having thermal conductivity higher than 10 W/m-° C. The inorganic filler can be metal oxide (e.g. aluminum oxide), metal nitride (e.g. aluminum nitride, boron nitride), ceramic or a combination thereof. By adding the heat-conductive filler 222 having higher thermal conductivity into poly(amic acid) solution 220, the thermal conductivity of the polyimide layer obtained from the poly(amic acid) solution 220 can be improved. The content of the heat-conductive filler 222 is about 10˜90 wt % of the solid content of the poly(amic acid) solution 222.

The preparation of the poly(amic acid) solution 220 and the following procedure of the copper clad laminate manufacturing process are demonstrated by the manufacturing system 200. However, the manufacturing process mentioned above is not limited by the manufacturing system 200, for example, it can be carried out in a smaller reactor accompanying with a smaller coating machine used in laboratory.

Referring to FIG. 1˜2, the poly(amic acid) solution 220 can be selectively stored in a reservoir 230 for supplying the poly(amic acid) solution 220 in the following coating procedure. When the step 120 is carried out, a predetermined amount of the poly(amic acid) solution 220 is delivered from the reservoir 230 to a coating apparatus 240. Meanwhile, the copper foil 250 is inserted from the entrance 262 of the film-formation apparatus 260 and is further driven to pass through a region below the coating apparatus 240 by a transmission apparatus 270, thereby coating the poly(amic acid) solution 220 on the surface of the copper foil 250. The transmission apparatus 270 can include a transmission wheel 272 used for delivering the copper foil 250 and a roller 274 used for supporting the copper foil 250.

The coating apparatus 240 can be a blade coater, a slot coater or an extrusion coater. The poly(amic acid) solution 220 is delivered from the coating apparatus 240 to the copper foil 250 by gravity force or pressure (e.g. gas pressure), and further coated on the copper foil 250. The coating apparatus 240 and the copper foil 250 are disposed with a predetermined distance D therebetween for coating the poly(amic acid) solution 220 on the copper foil 250 with various thicknesses. The predetermined distance D is about 60˜1500 um. Various thicknesses of the poly(amic acid) solution 220 can be obtained by adjusting the predetermined distance D or pressure magnitude. Thus, the simplified process disclosed in the present invention is able to provide method for coating poly(amic acid) of various thicknesses which conventionally requires inconvenient switch in different coating process.

A step 130 is carried out after the poly(amic acid) 220 is coated on the copper foil 250. The copper foil 250 passes through a heating apparatus 280. The poly(amic acid) solution 220 coated on the copper foil 250 is heated in a nitrogen gas environment with multi-stages heating process to form a polyimide layer 290. Thus, a copper clad laminate including the polyimide layer 290 and the copper foil 250 is obtained. The heat-conductive filler is distributed in the polyimide layer 290. The copper clad laminate can be further output from the outlet 264 of the film formation apparatus 260.

### MANUFACTURING EXAMPLE OF COPPER CLAD LAMINATE

### Example 1 (E1)

8.94 g of 1,4-diamino benzene and 6.62 g of oxydianiline are mixed together and dissolved in 252 g of N-methyl-2-pyrrolidone first. Then, 12 g of aluminum oxide powder is added into above solution and stirred for 1 hour. After that, 3.57 g of 1,2,4,5-benzenetetracarboxylic dianhydride and 28.88 g of 3,3′4,4′-biphenyltetracarboxylic dianhydride are added into the above solution and stirred at 30° C. for 6 hours, to obtain a poly(amic acid) solution including 19.23% solid content. The poly(amic acid) solution is further coated on the copper foil. The copper foil coated with the poly(amic acid) solution is heated in a nitrogen gas environment with multi-stages heating process to obtain a copper clad laminate having a polyimide layer of 25 um thickness. The heating temperature is in a range from 80° C. to 400° C.

### Example 2 (E2)

8.67 g of 1,4-diamino benzene and 6.42 g of oxydianiline are mixed together and dissolved in 252 g of N-methyl-2-pyrrolidone first. Then, 14.4 g of aluminum oxide powder is added into above solution and stirred for 1 hour. After that, 3.83 g of 4,4′-oxydiphthalic anhydride and 29.07 g of 3,3′4,4′-biphenyl tetracarboxylic dianhydride are added into the above solution and stirred at 30° C. for 6 hours, to obtain a poly(amic acid) solution including 19.85% solid content. The poly(amic acid) solution is further coated on the copper foil. The copper foil coated with the poly(amic acid) solution is heated in a nitrogen gas environment with multi-stages heating process to obtain a copper clad laminate having a polyimide layer of 25 um thickness. The heating temperature is in a range from 80° C. to 400° C.

### Comparative Example (R1)

8.94 g of 1,4-diamino benzene and 6.62 g of oxydianiline are mixed together and dissolved in 252 g of N-methyl-2-pyrrolidone first. Then, 3.57 g of 1,2,4,5-benzenetetracarboxylic dianhydride and 28.88 g of 3,3′4,4′-biphenyltetra carboxylic dianhydride are added into the above solution and stirred at 30° C. for 6 hours to obtain a poly(amic acid) solution including 16% solid content. The poly(amic acid) solution is further coated on the copper foil. The copper foil coated with the poly(amic acid) solution is heated in a nitrogen gas environment with multi-stages heating process to obtain a copper clad laminate having a polyimide layer of 25 um thickness. The heating temperature is in a range from 80° C. to 400° C.

### Comparative Example (R2)

8.67 g of 1,4-diamino benzene and 6.42 g of oxydianiline are mixed together and dissolved in 252 g of N-methyl-2-pyrrolidone first. Then, 3.83 g of 4,4′-oxydiphthalic anhydride and 29.07 g of 3,3′4,4′-biphenyltetracarboxylic dianhydride are added into the above solution and stirred at 30° C. for 6 hours to obtain a poly(amic acid) solution including 16% solid content. The poly(amic acid) is further coated on the copper foil. The copper foil coated with the poly(amic acid) solution is heated in a nitrogen gas environment with multi-stages heating process to obtain a copper clad laminate having a polyimide layer of 25 um thickness. The heating temperature is in a range from 80° C. to 400° C.

### Properties Analysis

The thermal conductivity, water uptake and electric properties of the polyimide layer on the copper clad laminate in above manufacturing examples are determined and shown in table. 1.

TABLE 1
Properties of polyimide layer

| | E1 | E2 | R1 | R2 |
|---|---|---|---|---|
| Thermal conductivity (W/m-° C.) | 0.5 | 0.6 | 0.05 | 0.05 |
| Water uptake (%) | 2.1 | 1.7 | 2.8 | 3.2 |
| Volume resistance (Ω-cm) | 10¹³ | 10¹³ | 10¹³ | 10¹³ |
| Surface resistance (Ω) | 10¹³ | 10¹³ | 10¹³ | 10¹³ |
| Breakdown voltage (KV) | 5.5 | 4.5 | 6 | 5.8 |

Referring to table.1, the thermal conductivity of the polyimide layer can be greatly increased from 0.05 W/m-° C. to 0.5˜0.6 W/m-° C. when the heat-conductive filler (e.g. aluminum oxide) is distributed in the polyimide layer, as observed from a comparison between E1 and R1, or E2 and R2. Therefore, the thermal conductivity of the copper clad laminate can be improved by forming the polyimide layer having the heat-conductive filler.

Besides, the polyimide layer of E1˜E2 possesses lower water uptake property than that of R1˜R2. The polyimide layer of E1˜E2 can possess improved dielectric property due to lower water uptake. The copper clad laminate includes such polyimide layer with improved dielectric property, which facilitates its application in high radio frequency electric circuit.

Referring to table. 1, the volume resistance and the surface resistance of the polyimide layer of E1˜E2 are 10¹³ Ω-cm and 10¹³ Ω, respectively, and the breakdown voltage of the polyimide layer is 4.5˜5.5 KV. Even though the aluminum oxide is distributed in the polyimide layer, the volume and surface resistances of the polyimide layer still can meet the requirement for manufacturing copper clad laminate. In addition, the breakdown voltage of the polyimide layer of E1 and E2, reduced but still higher than 2 KV, can meet the requirement of manufacturing copper clad laminate.

Although the present invention has been described in considerable detail with reference to certain embodiments thereof, other embodiments are possible. Therefore, their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing a metal clad laminate, comprising:
preparing a poly(amic acid) solution, wherein the poly(amic acid) solution comprises a heat-conductive filler, poly(amic acid) and a solvent, the thermal conductivity of the heat-conductive filler is higher than 10 W/m-° C., and the content of the heat-conductive filler is about 10˜90 wt % of the solid content of the poly(amic acid) solution;
coating the poly(amic acid) solution on a metal foil; and
heating the poly(amic acid) solution to form a polyimide layer on the metal foil.

2. The metal clad laminate manufacturing method of claim 1, wherein the heat-conductive filler is selected from a group consisting of metal oxide, metal nitride, ceramic and a combination thereof.

3. The metal clad laminate manufacturing method of claim 2, wherein the heat-conductive filler is selected from a group consisting of aluminum oxide, aluminum nitride, boron nitride and a combination thereof.

4. The metal clad laminate manufacturing method of claim 1, wherein the poly(amic acid) is prepared by reacting at least one aromatic diamine monomer with at least one aromatic dianhydride.

5. The metal clad laminate manufacturing method of claim 4, wherein the aromatic diamine monomer is selected from a group consisting of 1,4-diamino benzene; 1,3-diamino-benzene-4,4′-oxydianiline, 3,4′-oxydianiline, 4,4′-methylene dianiline, N,N′-diphenylethylenediamine, diaminobenzophenone, diamino diphenyl sulfone, 1,5-naphenylene diamine, 4,4′-diaminodiphenyl sulfide, 1,3-bis(3-aminophenoxy)benzene, 1,4-bis(4-aminophenoxy)benzene, 1,3-bis(4-aminophenoxy)benzene, 2,2-bis[4-(4-aminophenoxy)phenoxy]propane, 4,4′-bis-(4-aminophenoxy)biphenyl, 4,4′-bis-(3-aminophenoxy)biphenyl, 1,3-bis(3-amino propyl)-1,1,3,3-tetramethyldisiloxane, 1,3-bis(3-aminopropyl)-1,1,3,3-tetraphenyl disiloxane, 1,3-bis(aminopropyl)-dimethyldiphenyl disiloxane and a combination thereof.

6. The metal clad laminate manufacturing method of claim 4, wherein the aromatic dianhydride monomer is selected from a group consisting of 1,2,4,5-benzenetetracarboxylic dianhydride, 3,3′4,4′-biphenyltetracarboxylic dianhydride, 4,4′-oxydiphthalic anhydride, benzophenonetetracarboxylic dianhydride, 3,3′,4,4′-diphenylsulfonetetracarboxylic dianhydride, 1,2,5,6-naphthalenetetra carboxylic dianhydride, naphthalenetetracarboxylic dianhydride, bis(3,4-di carboxyphenyl)dimethylsilane dianhydride, 1,3-bis(4′-phthalicanhydride)tetra methyldisiloxane and a combination thereof.

7. The metal clad laminate manufacturing method of claim 1, wherein the solvent is selected from a group consisting of N,N-dimethylformamide, dimethylacetamide, dimethylsulfoxide, N-methyl-2-pyrrolidone, gamma butyrolatone and a combination thereof.

8. The metal clad laminate manufacturing method of claim 1, wherein the material of the metal foil is copper, aluminum, iron or alloy.

9. The metal clad laminate manufacturing method of claim 1, further comprising storing the poly(amic acid) solution in a reservoir.

10. The metal clad laminate manufacturing method of claim 9, wherein the procedure of coating the poly(amic acid) solution on a metal foil comprising:
delivering the metal foil by using a transmission apparatus;
delivering a predetermined amount of the poly(amic acid) from the reservoir to a coating apparatus; and
coating the poly(amic acid) solution on the metal foil by using the coating apparatus.

11. The metal clad laminate manufacturing method of claim 10, wherein the poly(amic acid) solution is delivered from the coating apparatus to the metal foil by gravity force and coated on the metal foil.

12. A metal clad laminate, comprising:
a metal foil; and
a polyimide layer located on a surface of the metal foil without any adhesive layer between the polyimide layer and the metal foil, wherein the polyimide layer comprises a heat-conductive filler, the thermal conductivity of the heat-conductive filler is higher than 10 W/m-° C. and the content of the heat-conductive filler is about 10˜90 wt %.

13. The metal clad laminate of claim 12, wherein the material of the metal foil is copper, aluminum, iron or alloy.

14. The metal clad laminate of claim 12, wherein the heat-conductive filler is selected from a group consisting of metal oxide, metal nitride, ceramic and a combination thereof.

15. The metal clad laminate of claim 14, wherein the heat-conductive filler is selected from a group consisting of aluminum oxide, aluminum nitride, boron nitride and a combination thereof.
